(19) United States
(12) Patent Application Publication
(10) Pub. No.: US 2023/0142254 A1
(43) Pub. Date: May 11, 2023

(54) GRAPH NEURAL NETWORK METHOD AND ASSOCIATED MACHINE AND SYSTEM

(71) Applicant: T-HEAD (SHANGHAI) SEMICONDUCTOR CO., LTD., SHANGHAI FREE TRADE AREA (CN)

(72) Inventors: YANHONG WANG, SHANGHAI (CN); TIANCHAN GUAN, SHANGHAI (CN); SHUANGCHEN LI, SUNNYVALE, CA (US); HONGZHONG ZHENG, LOS GATOS, CA (US)

(21) Appl. No.: 17/583,496

(22) Filed: Jan. 25, 2022

(30) Foreign Application Priority Data
Nov. 5, 2021 (CN) 202111304147.6

(51) Int. Cl. G06N 3/10; G06F 9/54

(52) U.S. Cl. CPC G06N 3/10; G06F 9/542

(57) ABSTRACT

The present application discloses a graph neural network processing method and associated machine and system. The graph neural network method is used for a master, wherein the master, a first worker and a second worker train the graph neural network in a distributed environment. The method includes: receiving a first request from the first worker and a second request from the second worker, wherein the first worker sends the first request to the master to obtain at least an attribute of a first requested node, and the second worker sends a second request to the master to obtain at least an attribute of a second requested node; determining whether the first requested node and the second requested node are the same nodes and generating a determination result accordingly; and selectively performing broadcast or unicast to the first worker and the second worker, at least based on the determination result.

### CROSS-REFERENCE TO RELATED APPLICATIONS

This application claims priority to China Application Serial Number 202111304147.6, filed on Nov. 5, 2021, which is incorporated by reference in its entirety.

### TECHNICAL FIELD

The present application relates to a neural network, particularly to a graph neural network processing method and an associated machine and system.

### BACKGROUND

In a distributed environment, multiple graph neural network (GNN) machines work together to train the graph neural network. For any node, most of the attributes of adjacent nodes are stored in different graph neural network machines. Therefore, when each node performs sampling of adjacent nodes, the data needs to be transmitted back and forth between the machines, and the transmission time becomes the bottleneck in the distributed computing, causing the overall training and reasoning time to increase significantly. Therefore, how to reduce the amount of data transmission between machines in a distributed environment has become one of the urgent problems in this field.

### SUMMARY OF THE INVENTION

One of the purposes of the present application is to provide a graph neural network processing method and a related machine and system to address the above-mentioned issues.

One embodiment of the present disclosure discloses a graph neural network processing method, for use in a master, which works jointly with a first worker and a second worker in a distributed environment to train the graph neural network, wherein the first worker and the second worker respectively store information of some of nodes of the graph neural network, the graph neural network method includes: receiving a first request sent from the first worker and a second request sent from the second worker, wherein the first worker sends the first request to the master to obtain at least an attribute of a first requested node, and the second worker sends the second request to the master to obtain at least an attribute of a second requested node; determining whether the first requested node and the second requested node are the same nodes and generating a determination result accordingly; and selectively performing broadcast or unicast to the first worker and the second worker, at least based on the determination result.

One embodiment of the present disclosure discloses a graph neural network processing method, for use in a first worker, which works jointly with a master and a second worker in a distributed environment to train the graph neural network, wherein the master, the first worker and the second worker respectively store information of some of nodes of the graph neural network, the graph neural network method includes: sending a first request to the master to obtain an attribute of the first node, wherein the first worker stores the attribute of the second node; receiving a broadcast content sent from the master; and subtracting the attribute of the second node from the broadcast content to obtain the attribute of the first node.

One embodiment of the present disclosure discloses a graph neural network machine, for use as a master, which works jointly with a first worker and a second worker in a distributed environment to train the graph neural network, wherein the master, the first worker and the second worker respectively store information of some of nodes of the graph neural network, the graph neural network machine includes: an input storage device, configured to store a first request sent from the first worker and a second request of the second worker, wherein the first worker sends the first request to the master to obtain at least an attribute of the a first requested node, and the second worker sends a second request to the master to obtain at least an attribute of the second requested node; and a controller, coupled to the input storage device, wherein the controller is configured to determine whether the first requested node and the second requested node are the same nodes, and generate a determination result accordingly; and the controller selectively performs broadcast or unicast to the first worker and the second worker at least based on the determination result.

One embodiment of the present disclosure discloses a graph neural network machine, for use as a first worker, which works jointly with a master and a second worker in a distributed environment to train the graph neural network, wherein the master, the first worker and the second worker respectively store information of some of nodes of the graph neural network, and the graph neural network machine includes: an input storage device, configured to store a broadcast content sent from the master, wherein the first worker sends the first request to the master to obtain at least an attribute of the first requested node, and the first worker stores the attribute of the second node; and a controller, coupled to the input storage device, wherein the controller subtracts the attribute of the second node from the broadcast content to obtain the attribute of the first node.

One embodiment of the present disclosure discloses a graph neural network system, including: a first machine, including the foregoing graph neural network machine; and a second machine, including the foregoing graph neural network machine.

The graph neural network method and the related machine and system provided by the present application can reduce the amount of data transmitted between each machine when training the graph neural network in a distributed environment, thereby reducing the overall training time.

### BRIEF DESCRIPTION OF THE DRAWINGS

FIG. 1 is a schematic diagram illustrating a graph neural network system.

FIG. 2 to FIG. 17 are schematic diagrams illustrating embodiments of operation of the machine used as a master.

FIG. 18 to FIG. 20 are schematic diagrams illustrating embodiments of operation of the machine used as a worker.

FIG. 21 is a flowchart illustrating a first embodiment of the graph neural network processing method of the present disclosure.

FIG. 22 is a flowchart illustrating a second embodiment of the graph neural network processing method of the present disclosure.

### DETAILED DESCRIPTION

The following disclosure provides many different embodiments or examples for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various embodiments. This repetition is for the purpose of simplicity and clarity and does not in itself dictate a relationship between the various embodiments and/or configurations discussed.

Further, spatially relative terms, such as “beneath”, “below”, “lower”, “above”, “upper,” and the like, may be used herein for ease of description to discuss one element or feature's relationship to another element(s) or feature(s) as illustrated in the drawings. These spatially relative terms are intended to encompass different orientations of the device in use or operation in addition to the orientation depicted in the drawings. The apparatus may be otherwise oriented (e.g., rotated by 90 degrees or at other orientations), and the spatially relative descriptors used herein may likewise be interpreted accordingly.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “the same” generally means within 10%, 5%, 1%, or 0.5% of a given value or range. Alternatively, the term “the same” means within an acceptable standard error of the mean when considered by one of ordinary skill in the art. As could be appreciated, other than in the operating/working examples, or unless otherwise expressly specified, all of the numerical ranges, amounts, values, and percentages (such as those for quantities of materials, duration of times, temperatures, operating conditions, portions of amounts, and the likes) disclosed herein should be understood as modified in all instances by the term “the same.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Here, ranges can be expressed herein as from one endpoint to another endpoint or between two endpoints. All ranges disclosed herein are inclusive of the endpoints, unless specified otherwise.

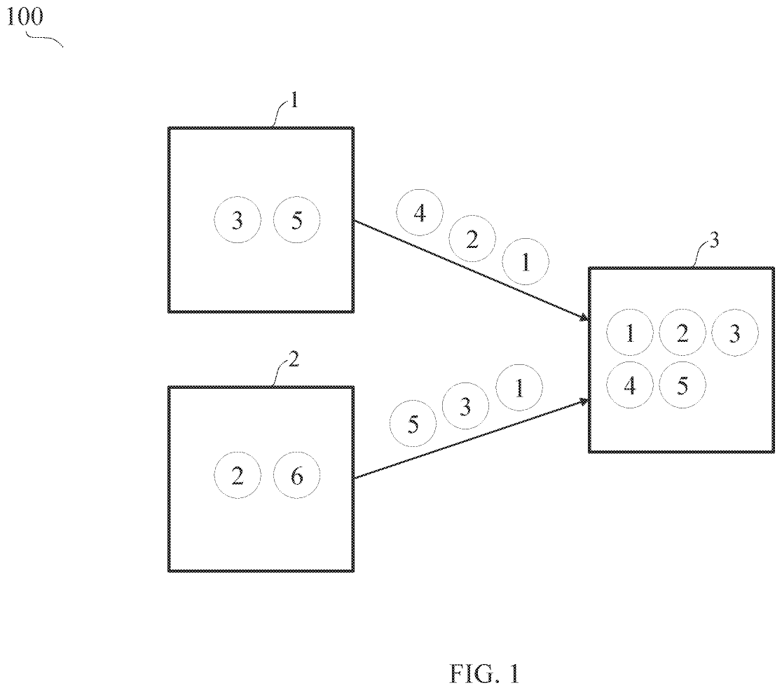

FIG. 1 is a schematic diagram illustrating a graph neural network (GNN) system 100, including a graph neural network machine 1, a graph neural network machine 2 and a graph neural network machine 3 (hereinafter, machine 1, machine 2 and machine 3). The graph neural network system 100 is in a distributed environment, and the machine 1, the machine 2 and the machine 3 jointly train the graph neural network. It should be noted that, in the present embodiment, the machine 1, the machine 2 and the machine 3 may locate in three electronic devices (e.g., computers) that are physically separated, or locate in a same electronic device, or some of them locates in a same electronic device and some of them locates in different electronic devices. The machine 1, the machine 2 and the machine 3 may be the core of a CPU or a GPU. That is, the machine 1, the machine 2 and the machine 3 may be the cores in the same or different CPU(s) or GPU(s). In the present embodiment, the machine 1, the machine 2 and the machine 3 respectively run a process to train the graph neural network. In the present embodiment, the machine 1, the machine 2 and the machine 3 perform data communication therebetween via the Message Passing Interface (MPI) protocol.

The graph neural network has a plurality of nodes, and the machine 1, the machine 2 and the machine 3 respectively store (e.g., in a cache) some of the nodes. When the machine 1, the machine 2 and the machine 3 train the graph neural network, they have to exchange information of the nodes (e.g., attributes of the nodes) with each other from time to time. This scenario takes places quite frequently when, for example, a certain node needs to sample the neighboring nodes. Take FIG. 1 for example, at a certain time, the machine 1 and the machine 2 are used as the workers and respectively send a request to the machine 3 used as a master. It should be noted that roles of the worker and master change depending on the roles of requesting and receiving requests; that is, during the training of the graph neural network, each of the machine 1, the machine 2 and the machine 3 has the opportunity to serve as the master and the worker.

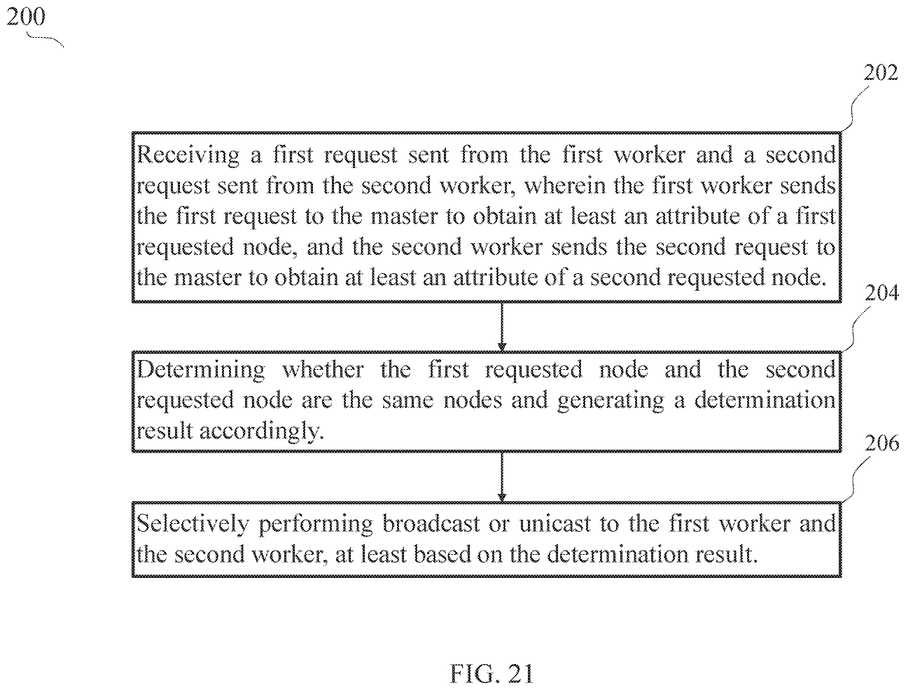

FIG. 21 is a flowchart of a graph neural network processing method according to the first embodiment of the present disclosure. The graph neural network processing method 200 is configured to be used in the machine 3 serving as the master of the graph neural network of the graph neural network system 100. In the present embodiment, the machine 3 serving as the master and the machine 1 and the machine 2 serving as the worker respectively store the information of some of nodes of the graph neural network. The information of some of the nodes stored in the machine 1, the machine 2 and the machine 3 can be all the same, partly the same and partly different, or completely different.

The graph neural network processing method 200 includes the Step 202 to the Step 204. In the Step 202, the machine 3 serving as the master receives a first request sent from the machine 1 serving as the worker and a second request sent from the machine 2 serving as the worker, wherein the machine 1 sends the first request to the machine 3 to obtain at least an attribute of the first requested node, and the machine 2 sends the second request to the machine 3 to obtain at least an attribute of the second requested node.

For example, in the embodiment of FIG. 1, the machine 1 has already stored the attributes of the node \textcircled{3} and the node \textcircled{5}; the machine 2 has already stored the attribute of the node \textcircled{2} and the node \textcircled{6} the machine 3 has already stored the attribute of the node \textcircled{1}, the node \textcircled{2}, the node \textcircled{3}, the node \textcircled{4}; and the node \textcircled{5}. For any possible reason, the machine 1 sends a request for the node \textcircled{1}, the node \textcircled{2} and the node \textcircled{4} to the machine 3; the machine 2 sends a request for the node \textcircled{1}, the node \textcircled{3} and the node \textcircled{5} to the machine 3.

According to the existing method, the machine 3 sends the attributes of the node \textcircled{1}, the node \textcircled{2} and the node \textcircled{4} to the machine 1 through 3 unicasts to complete the request of the machine 1, and the machine 3 sends the attributes of the node \textcircled{1}, the node \textcircled{3} and the node \textcircled{5} to the machine 2 through 3 unicasts to complete the request of the machine 2. However, in the Step 204 of the graph neural network method 200, the machine 3 serving as the master determines whether said the request node and the second request node are the same nodes, and generates a determination result accordingly. Then, in the Step 206, the machine 3 serving as the master selectively performs broadcast or unicast to the machine 1 as well as the machine 2 based at least on the determination result.

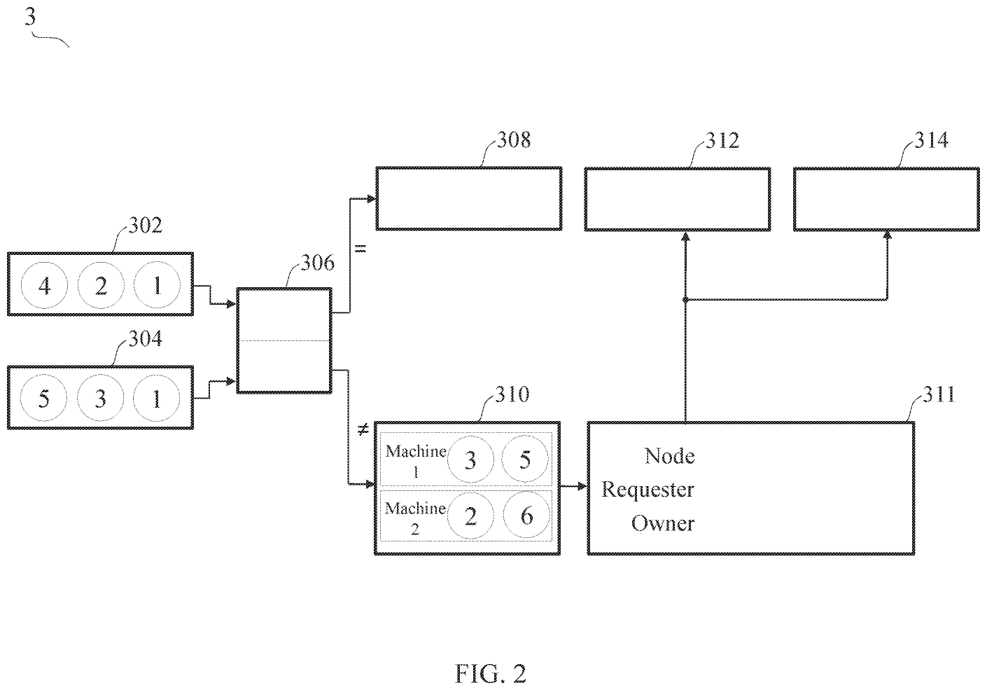

In other words, embodiments of the present disclosure may comprehensively refer to known information to determine whether some of the original 6 unicast can be combined and compressed into one broadcast, so as to reduce the overall data transmission time. Hereinafter, several implementation details of the graph neural network method 200 will be explained in more detail through the schematic diagrams of the embodiment of the operation of the machine 3 serving as the master shown in FIG. 2 to FIG. 17.

Specifically, the requested nodes are categorized into three types according to the present disclosure.

The first one of the three types is a repetitive request type, wherein a node being the repetitive request type means that the node is requested by two workers at the same time. From the scenario of FIG. 1, the type of node \textcircled{1} is the repetitive request type. The node attribute of the repetitive request type can be sent to two workers in need thereof at the same time through broadcast, so that the original two unicasts are reduced to one broadcast.

The second one of the three types is a pending paring type. From the scenario of FIG. 1, the node \textcircled{2}, the node \textcircled{3}, the node \textcircled{5} are the pending paring types. Specifically, the node \textcircled{2} is requested by the machine 1, and the machine 2 happens to store the node \textcircled{2}, and the machine 2 happens to send a request to the machine 3 at the same time, the node \textcircled{3} is requested by the machine 2, and the machine 1 happens to store the node \textcircled{3}, and the machine 1 happens to send a request to the machine 3 at the same time; the node \textcircled{5} is requested by the machine 2, and the machine 1 happens to store the node \textcircled{5}, and the machine 1 happens to send a request to the machine 3 at the same time. It should be noted that the machine 3 has recorded therein the storage situation of the attributes of a plurality of nodes in the graph neural network in the machine 1 and the machine 2. Thus, the storage situation can be used in combination with the requests of the machine 1 and the machine 2 to determine whether the requested nodes are of the pending paring type.

The node of the pending paring type in the request from the machine 1 can be paired with the node of the pending paring type in the request from the machine 2, and then sent to both the machine 1 and the machine 2 by means of a broadcast after the computation. For example, the machine 3 can sum up the attribute of the node \textcircled{2} and the attribute of the node \textcircled{3} and then sends them to both the machine 1 and the machine 2 by means of a broadcast. The machine 1 can simply subtract the attribute of the node \textcircled{3} (originally stored in the machine 1) from the received result to obtain the attribute of the node \textcircled{2}. In certain embodiments, operations other than addition, such as multiplication, etc., may also be used. It should be noted that if there are cases where the nodes of the pending paring type cannot be fully paired, such as in the scenario in FIG. 1, where after the node \textcircled{2} and the node \textcircled{3} are paired, the node \textcircled{5} is left alone, the machine 3 will still send the attribute of the node \textcircled{5} to the machine 2 by means of unicast.

The last of the three types is a remaining type; that is, all the nodes that do not belong to either the repetitive request type or the pending paring type are of the remaining type. The machine 3 sends the attributes of the nodes of the remaining type to the request party by means of unicast.

In sum, the machine 3 may selectively perform broadcast or unicast to the machine 1 and the machine 2 at least based on requests of the machine 1 and the machine 2.

FIG. 2 to FIG. 17 illustrate several components. However, it should be noted that the components shown in FIG. 2 to FIG. 17 are for illustrative purposes, and may be adjusted or modified depending on the actual architecture of the machine 3, as long as they can achieve the same purpose. For example, the machine 3 includes a lookup table 310 that records the storage situation of the machine 1 and the machine 2 of the attributes of a plurality of nodes in the graph neural network. In this embodiment, a content addressable storage medium (CAM) can be used, but the present disclosure is not limited thereto.

As shown in FIG. 2, when the machine 3 receives the request sent from the machine 1, the controller in the machine 3 (not shown in the drawings) will store the numbers (also referred to as “indexes”) of the nodes (the node \textcircled{1}, the node \textcircled{2} and the node \textcircled{4} that the machine 1 requested (e.g., the node \textcircled{1} is numbered as 1, the node \textcircled{2} is numbered as 2, the node \textcircled{4} is numbered as 4) in a first input storage device 302; when the machine 3 receives the request sent from the machine 2, it stores the numbers of the nodes (the node \textcircled{1}, the node \textcircled{3} and the node \textcircled{5} that machine 2 requested in a second input storage device 304. The first input storage device 302 and the second input storage device 304 may be a first-in-first-out (FIFO) storage device. In the present embodiment, in the request sent from the machine 1, the node \textcircled{1}, the node \textcircled{2} and the node \textcircled{4} are arranged sequentially in the numbers; in the request sent from the machine 2, the node \textcircled{1}, the node \textcircled{3} and the node \textcircled{5} are arranged sequentially in the numbers. Therefore, the numbers of the node \textcircled{1}, the node \textcircled{2} and the node \textcircled{4} will sequentially enter into the first input storage device 302; the node \textcircled{1}, the node \textcircled{3} and the node \textcircled{5} will sequentially enter into the second input storage device 304. In subsequent operations, the numbers of the node \textcircled{1}, the node \textcircled{2} and the node \textcircled{4} are also sequentially read out of the first input storage device 302; the numbers of the node \textcircled{1}, the node \textcircled{3} and the node \textcircled{5} also sequentially read from the second input storage device 304.

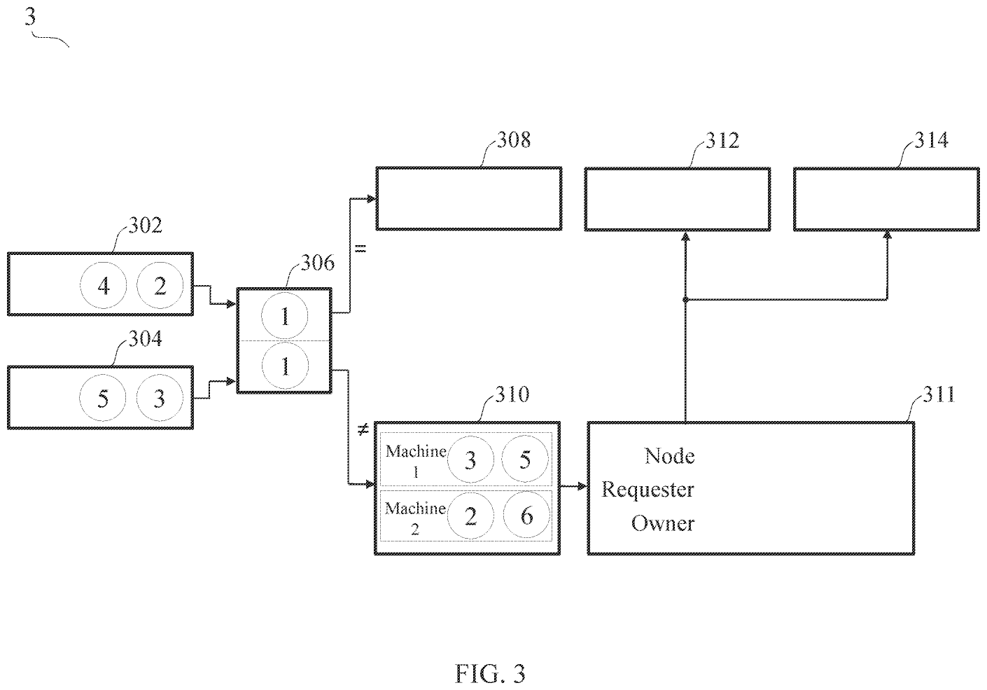

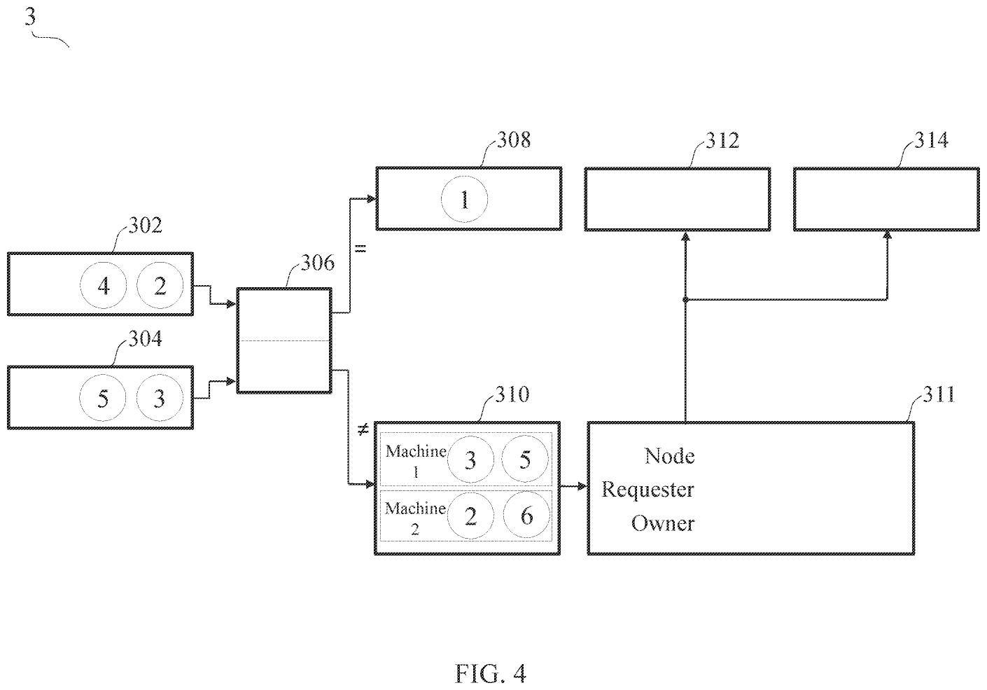

Next, the controller of the machine 3 controls the first input storage device 302 and the second input storage device 304 to output the number respectively, as shown in FIG. 3, the first input storage device 302 and the second input storage device 304 both output the number of the node \textcircled{1}; to the comparator 306. Hence, the comparator 306 store two same numbers. The comparator 306 determines whether the two numbers entering thereinto are the same. If yes, then the controller of the machine 3 determines that the nodes having said number are of the repetitive request type, and stores the attribute of the node corresponding to the number in the first output storage device 308, and clears the two numbers in the comparator 306. As shown in FIG. 4, the controller stores the attribute of the node \textcircled{1} in the first output storage device 308. Then, the node attributes stored in the first output storage device 308 will be sent to the machine 1 and the machine 2 by broadcasting.

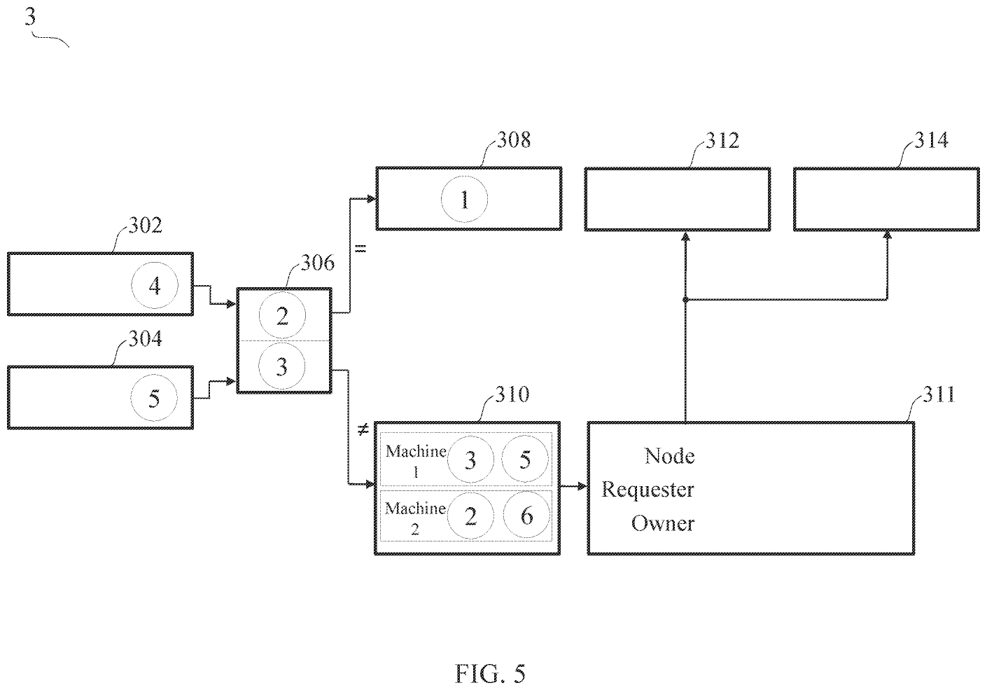

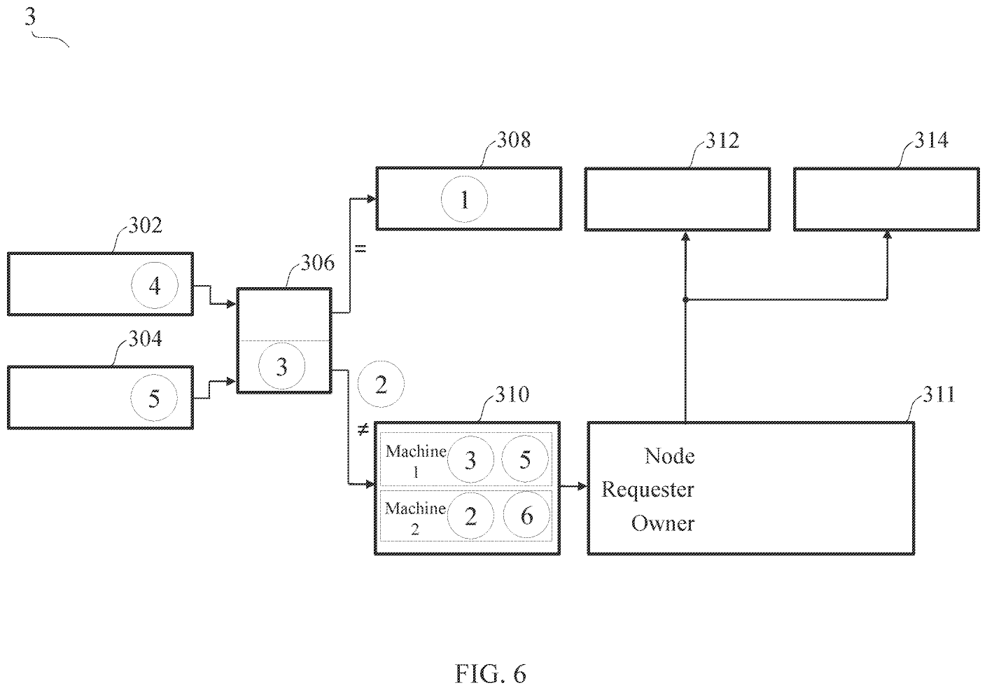

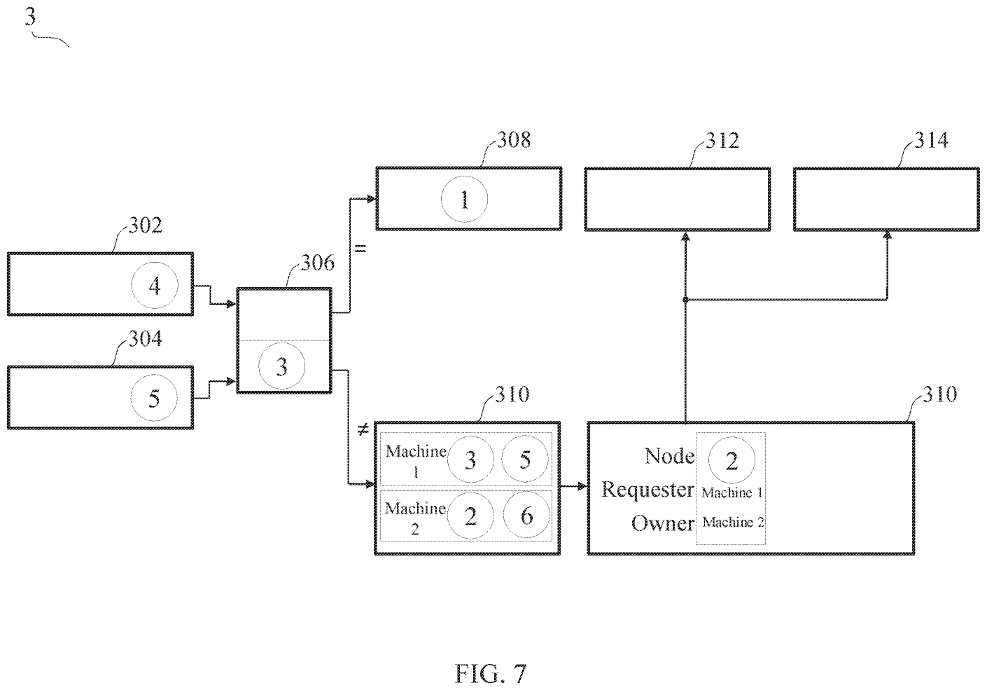

Next, reference is made to FIG. 5, in which the controller of the machine 3 controls the first input storage device 302 to output the number of the node \textcircled{2} to the comparator 306; and controls the second input storage device 304 to output the number of the node \textcircled{3} to the comparator 306 as well. In this way, the comparator 306 stores two different numbers. In FIG. 6, the comparator 306 determines whether the two numbers entering thereinto are the same, if not, the smaller number is outputted and cleared from the comparator 306; hence, the number of the node \textcircled{2} will be outputted. The controller of the machine 3 also checks the storage situation of the attribute of the node \textcircled{2} in each of the other machines in the lookup table 310. Specifically, the concern is whether the attribute of node \textcircled{2} is stored in other machines that simultaneously issue the request, that is, the machine 2. Since it is known from the lookup table 310 that the attribute of the node \textcircled{2} is stored in the machine 2, the controller of the machine 3 determines that the node \textcircled{2} is of the pending paring type, and as shown in FIG. 7, the number, requester, and owner of the node \textcircled{2} are recorded in the register 311.

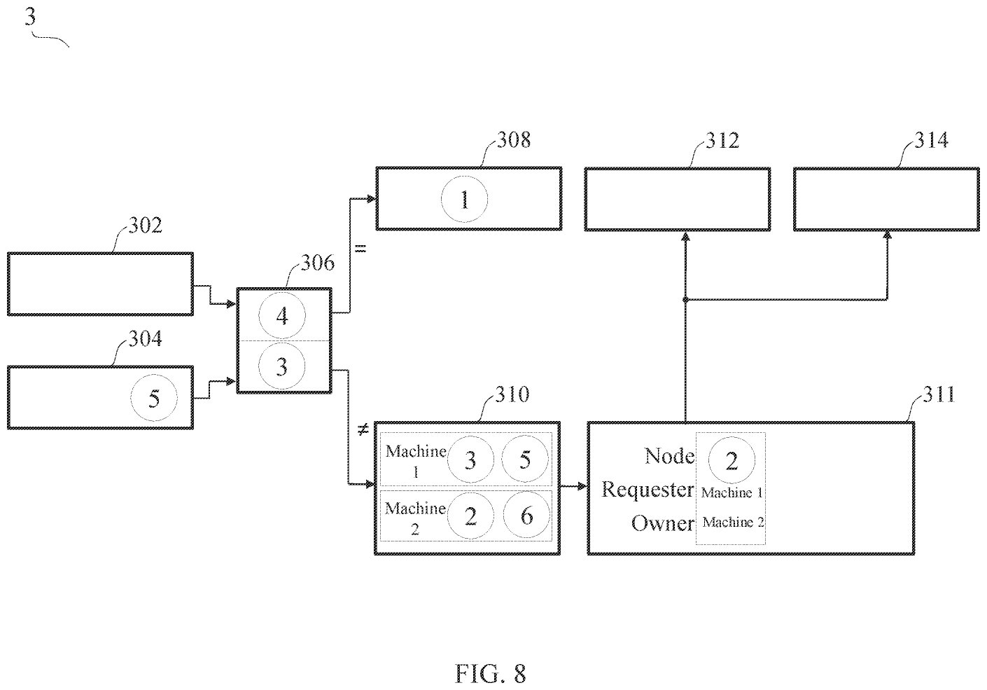

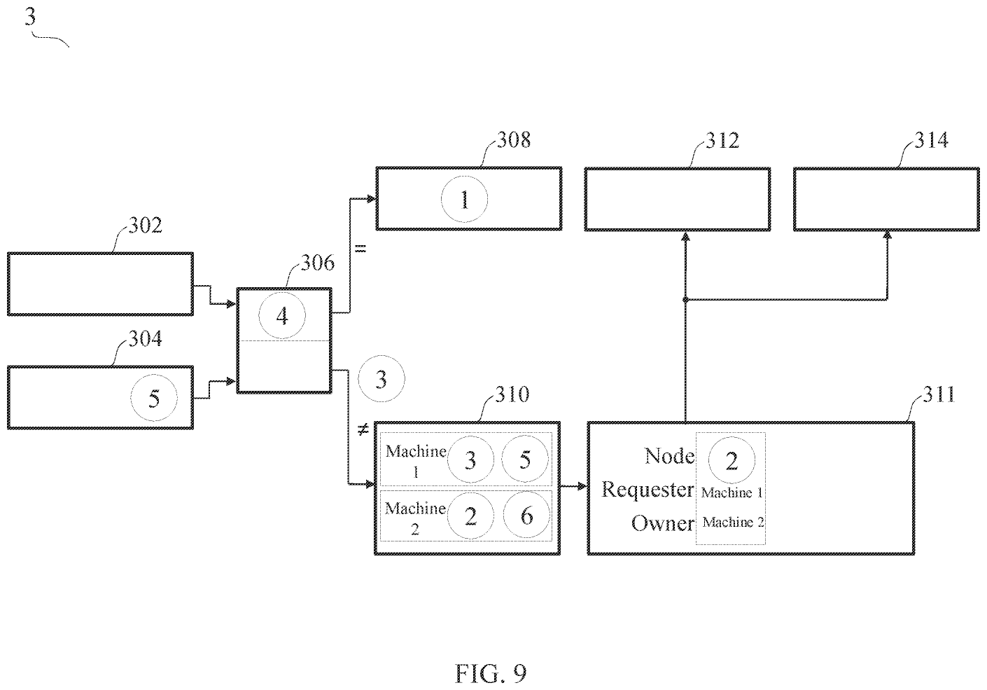

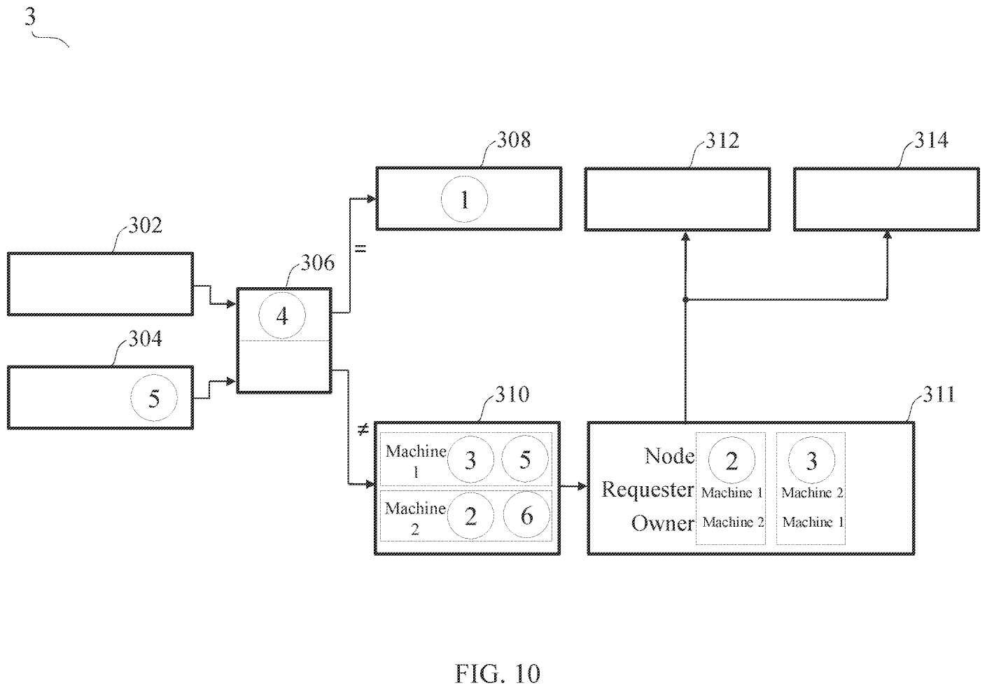

After the number of the node \textcircled{2} is cleared from the comparator 306, only the number of the node \textcircled{3} remains in the comparator 306, so as shown in FIG. 8, the controller of the machine 3 will control the first input storage device 302 to output the number of node \textcircled{4} to the comparator 306. Next, in FIG. 9, the comparator 306 determines that the number of the node \textcircled{3} and the number of the node \textcircled{4} are not the same, and the number of the node \textcircled{3} is smaller, so the number of the node \textcircled{3} is outputted and the number of the node \textcircled{3} is cleared from the comparator 306. Then, it is known from the lookup table 310 that the attribute of the node \textcircled{3} is stored in the machine 1, so the controller of the machine 3 determines that the node \textcircled{3} is of the pending paring type, and as shown in FIG. 10, the number, requester, and owner of the node \textcircled{3} are recorded in the register 311.

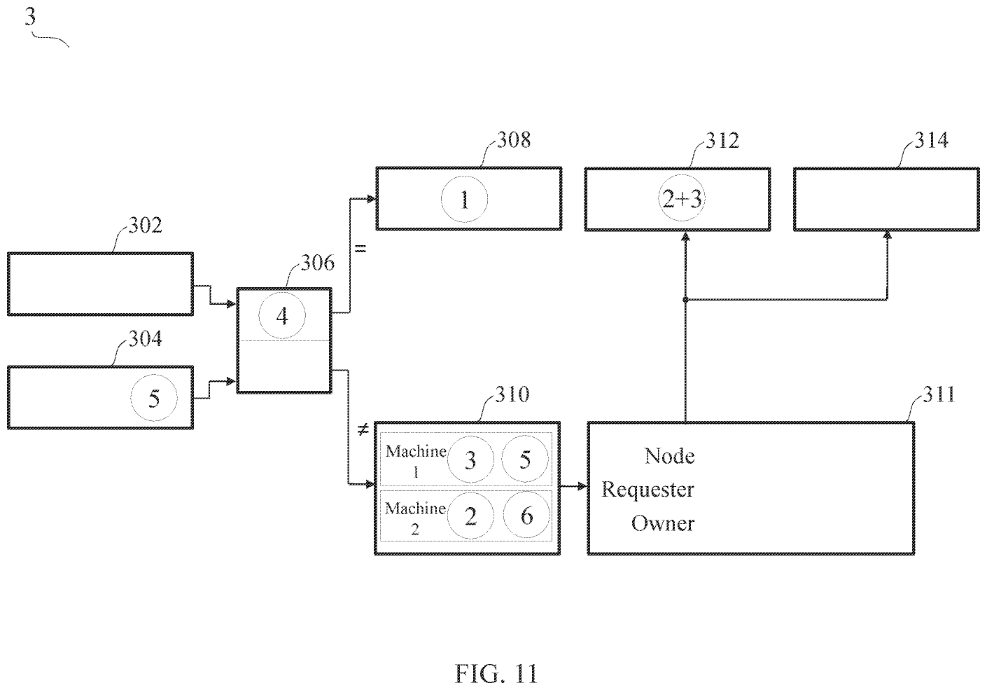

In FIG. 11, the controller of the machine 3 determines that the node \textcircled{2} and the node \textcircled{3} can be paired with each other, so the attribute of the node \textcircled{2} and the attribute of the node \textcircled{3} are summed and placed in the second output storage device 312, and the related information of the node \textcircled{2} and the node \textcircled{3} are cleared from the register 311. After that, the data stored in the second output storage device 312 will be sent to the machine 1 and the machine 2 in a broadcast manner. Specifically, the result of the addition of the attribute of the node \textcircled{2} and the attribute of the node \textcircled{3} will be broadcast to the machine 1 and the machine 2.

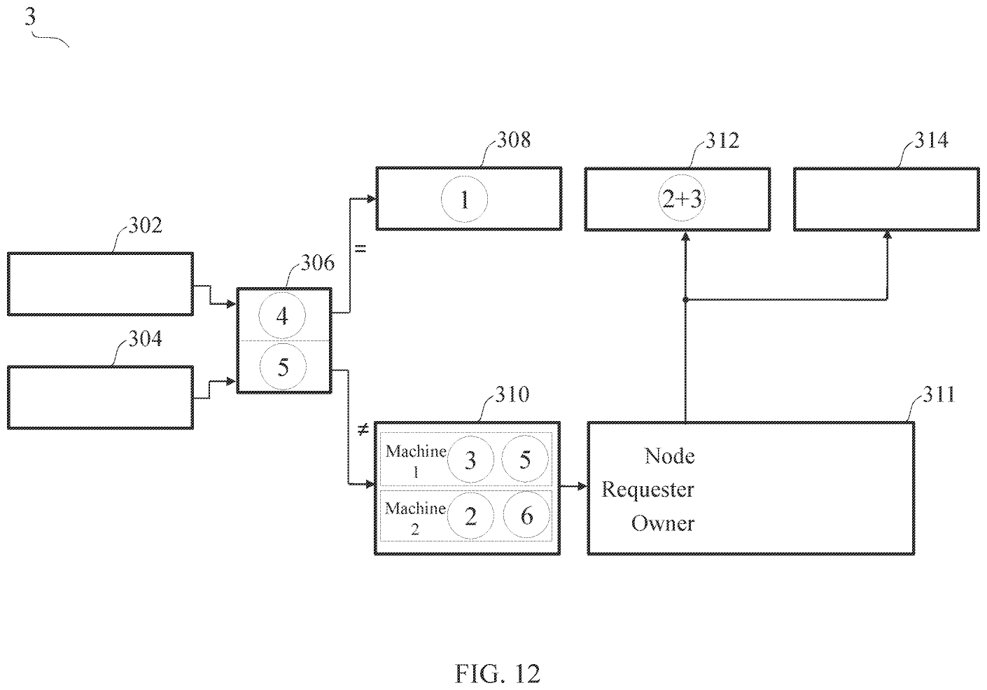

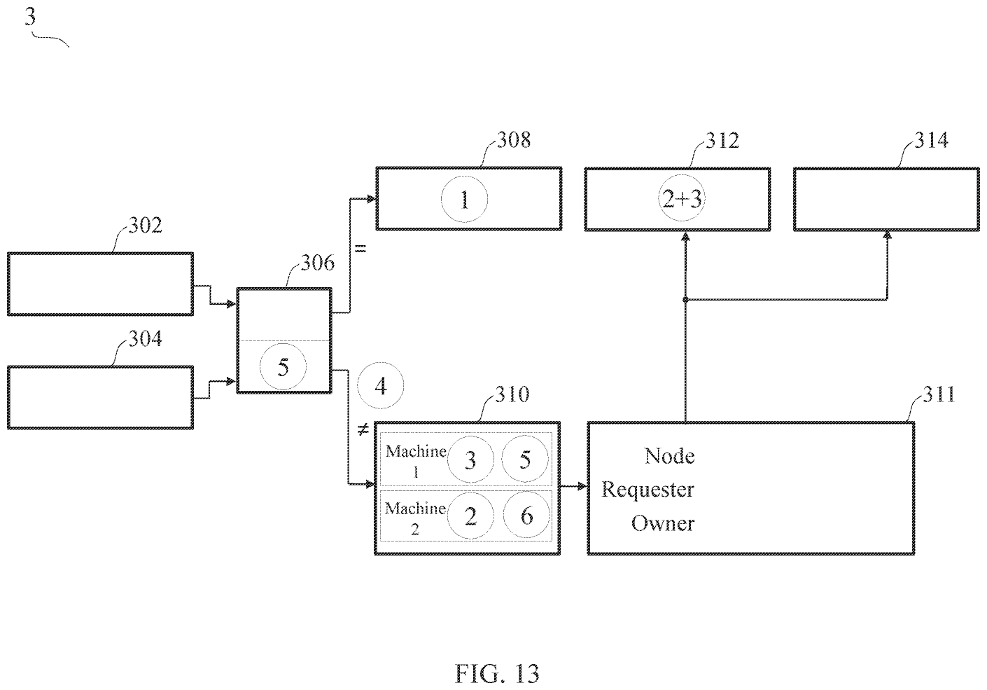

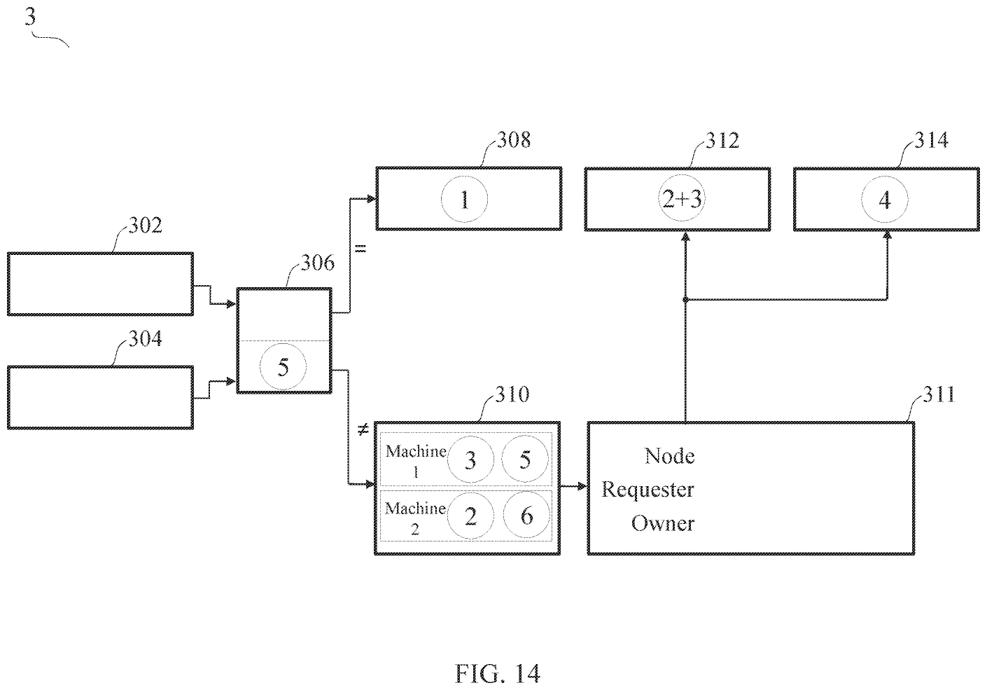

After the number of the node \textcircled{3} is cleared from the comparator 306, only the number of the node \textcircled{4} remains in the comparator 306, so as shown in FIG. 12, the controller of the machine 3 will control the second input storage device 304 to output the number of the node \textcircled{5} to the comparator 306. Next, in FIG. 13, the comparator 306 determines that the number of the node \textcircled{4} and the number of the node \textcircled{5} are not the same, and the number of the node \textcircled{4} is smaller, so the number of the node \textcircled{4} is outputted and the number of the node \textcircled{4} is cleared from the comparator 306. Then it is known from the lookup table 310 that neither the machine 1 nor the machine 2 has the attribute of the node \textcircled{4}, so the controller of the machine 3 determines that the node \textcircled{4} is of the remaining type, and as shown in FIG. 14, the attribute of the node \textcircled{4} is placed in the third output storage device 314. After that, the attributes of the nodes stored in the third output storage device 314 will be sent to the machine 1 and the machine 2 in a unicast manner. The first output storage device 308, the second output storage device 312, and the third output storage device 314 may be first-in first-out storage devices.

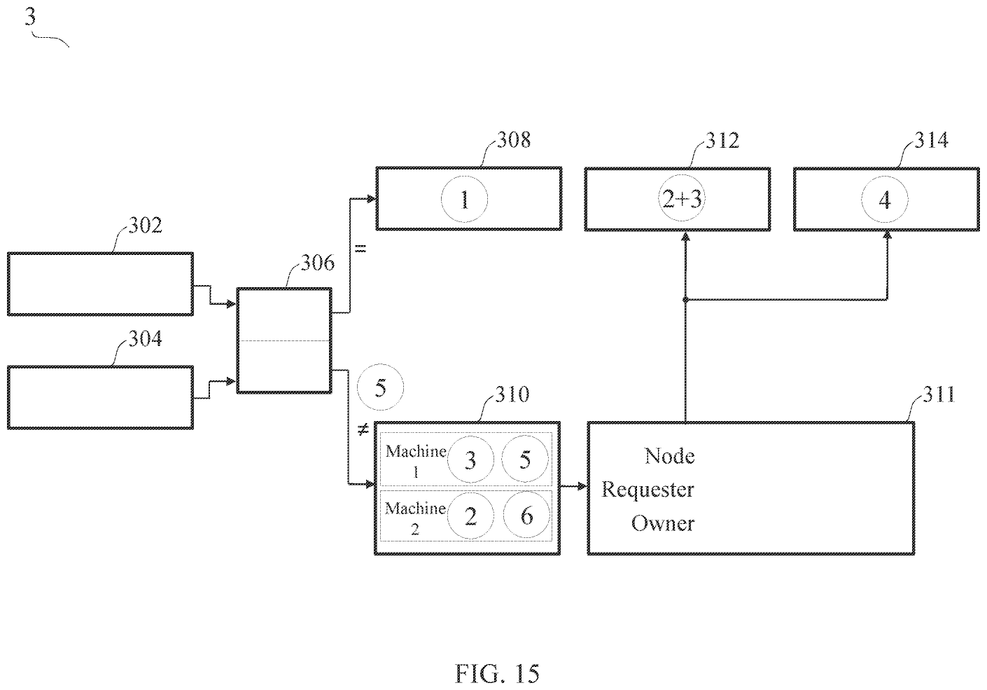

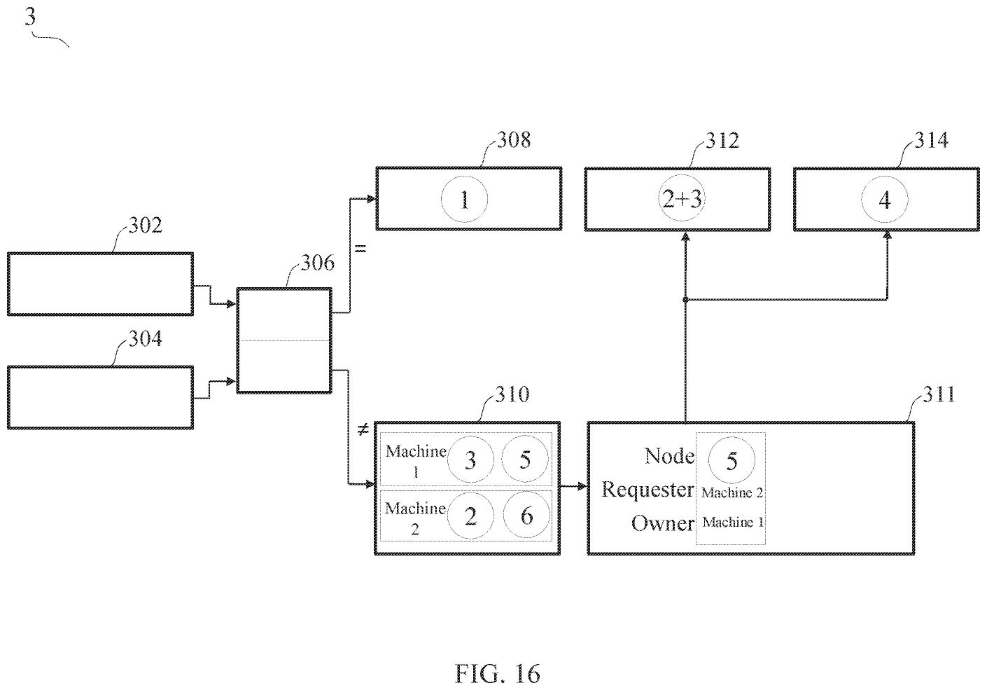

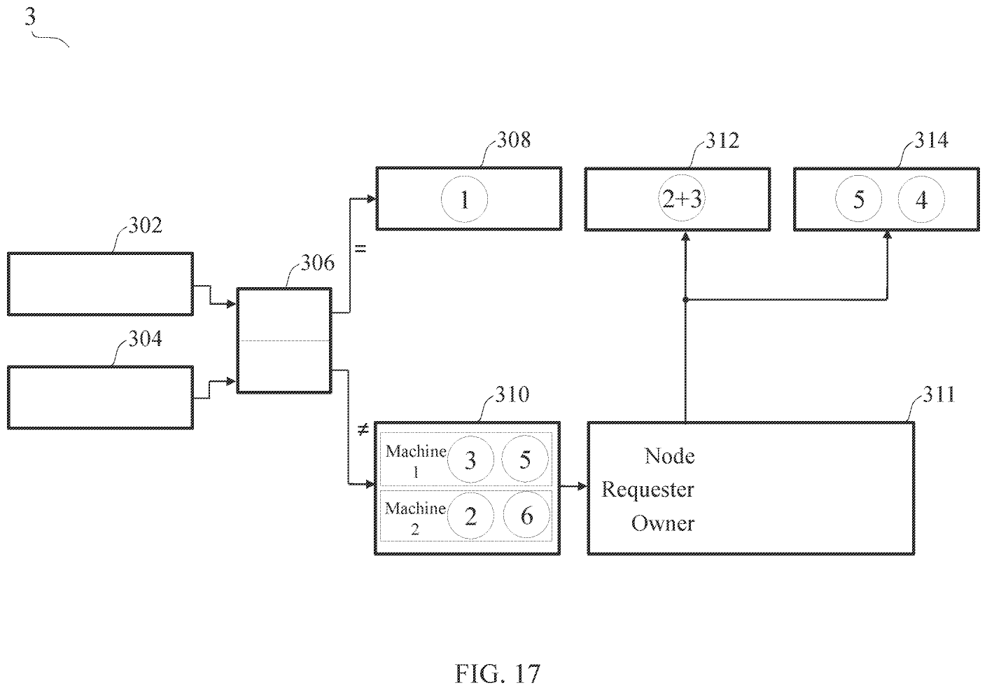

Next, as shown in FIG. 15, since both the first input storage device 302 and the second input storage device 304 have been emptied, the number of the node \textcircled{5} stored in the comparator 306 is outputted and it is determined whether it is of the pending paring type. It can be seen in FIG. 16 that the node \textcircled{5} is determined to be of the pending paring type, so the number, requester, and owner of the node \textcircled{5} are recorded in the register 311. However, since there are no other possible objects to be paired, the controller of the machine 3 places the attribute of the node \textcircled{5} in the third output storage device 314, as shown in FIG. 17, and the related information of the node \textcircled{5} is cleared from the register 311.

As mentioned above, the attributes of the nodes in the first output storage device 308 and the second output storage device 312 or the computed results of the attributes of multiple nodes will be broadcast to the machine 1 and machine 2; the attributes of the nodes in the third output the storage device 314 are sent to the machine 1 or the machine 2 in a unicast manner. In this embodiment, in a time-sharing manner, the attribute of the node \textcircled{1} will be sent to the machine 1 and the machine 2 in sequence through the first broadcast, and the attribute of the node \textcircled{2} will be correlated with the attribute of the node \textcircled{3} through the second broadcast. The result of the addition is sent to the machine 1 and the machine 2, the attribute of the node \textcircled{4} is sent to the machine 1 through the first unicast, and the attribute of the node \textcircled{5} is sent to the machine 2 through the second unicast. That is, the original six unicasts are replaced by two broadcasts and two unicasts, which reduces the time of data transmission.

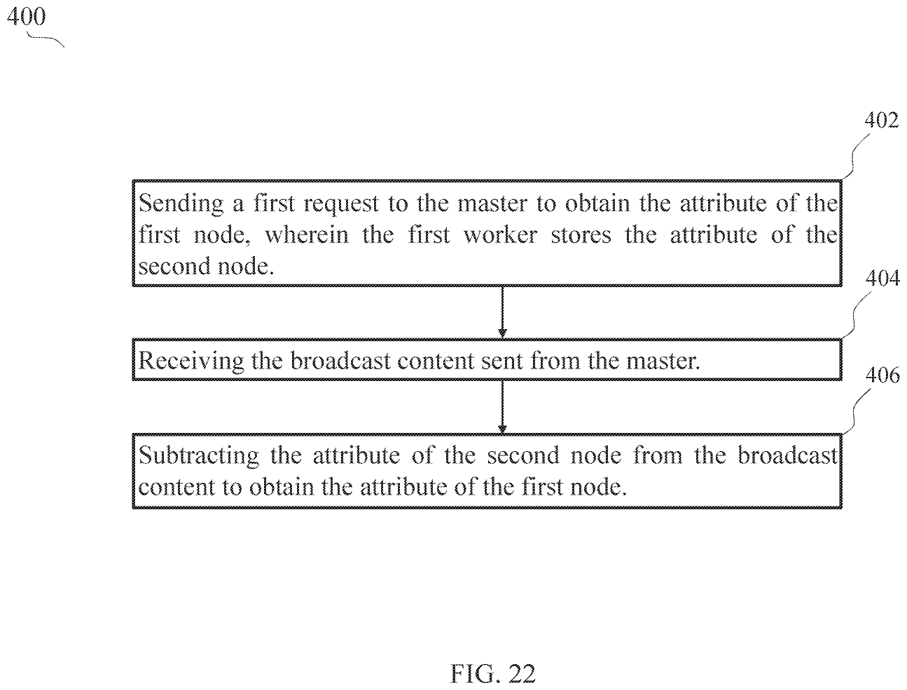

FIG. 22 is a flowchart of a graph neural network processing method according to the second embodiment of the present disclosure. The graph neural network processing method 400 is configured to be used in the machine 1 serving as the worker of the graph neural network of the graph neural network system 100; and of course, it is applicable to the machine 2, serving as the worker.

The main scenario shown in the graph neural network processing method 400 is that the first node requested by the machine 1 and the second node requested by the machine 2 are both of pending paring type (that is, the machine 1 stores the attribute of the second node, the machine 2 stores the attribute of the first node), and the machine 3 pairs the first node and the second node with each other, sums up the attribute of the first node and the second node, and sends the result to the machine 1 and the machine 2 in a broadcast manner.

The graph neural network processing method 400 includes the Step 402 to the Step 404. In the Step 402, the machine 1 serving as the worker sends a first request to the machine 3 serving as the master to obtain the attribute of the first node; at the same time, the machine 2 serving as the worker sends a second request to the machine 3 to obtain the attribute of the second node, and the machine 1 stores the attribute of the second node. Then, in the Step 404, the machine 1 receives the broadcast content sent from the machine 3, wherein the broadcast content includes a summation result of the attribute of the first node and the attribute of the second. Consequently, in the Step 406, the machine 1 subtracts the attribute of the second node from the broadcast content to obtain the attribute of the first node.

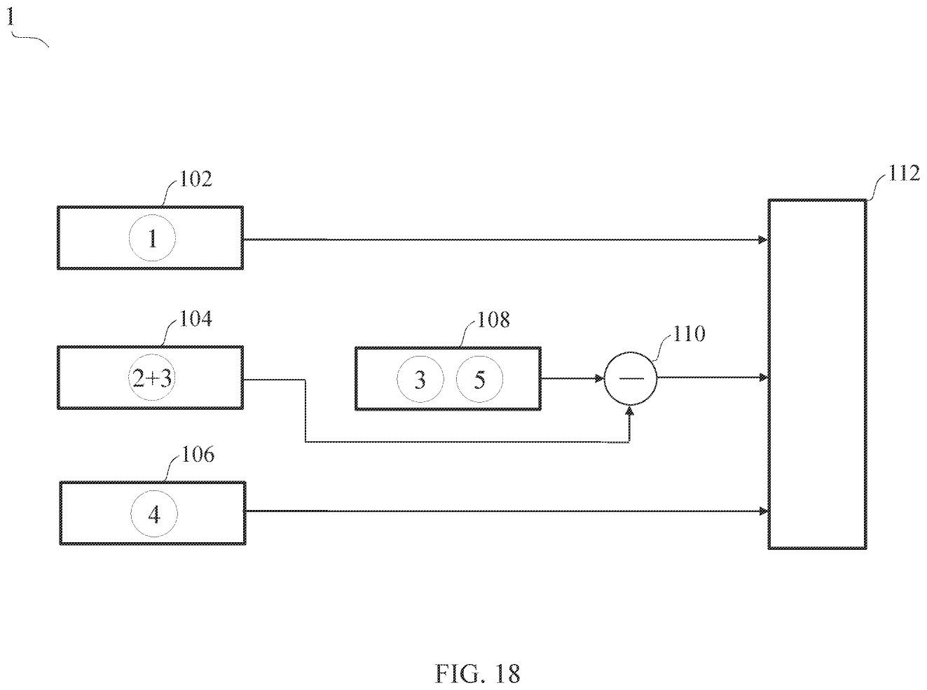

Hereinafter, several implementation details of the graph neural network processing method 400 will be explained in more detail through the schematic diagrams of the embodiment of the operation of the machine 1 serving as a worker shown in FIG. 18 to FIG. 20. FIG. 18 to FIG. 20 includes several components, but it should be noted that the components shown in FIG. 18 to FIG. 20 are for illustrative purposes, and can actually be adjusted or modified according to the machine 1 architecture, as long as the same purpose can be achieved. For example, the storage device 108 included in the machine 1 records the attributes of the node \textcircled{3} and the node \textcircled{5}. In this embodiment, the storage device 108 can be implemented using a cache, but the present disclosure is not limited thereto.

As shown in FIG. 18, when the machine 1 receives the response from machine 3 to the request of the machine 1, the controller in the machine 1 (not shown in the drawings) will place the attribute of the received node \textcircled{1} in the first input storage device 102; and place the summation result of the attribute of the node \textcircled{2} and the attribute of the node \textcircled{3} in the second input storage device 104; and place the attribute of the node \textcircled{4} in the third input storage device 106. In the present embodiment, the first input storage device 102 is used to store the attributes of the nodes of the first output storage device 308 from the machine 3; the second input storage device 104 is used to store the computation result of attributes of nodes by the second output storage device 312; and the third input storage device 106 is used to store the attributes of the nodes from the third output storage device 314 of the machine 3. In this embodiment, the first input storage device 102, the second input storage device 104, and the third input storage device 106 may be FIFO storage devices.

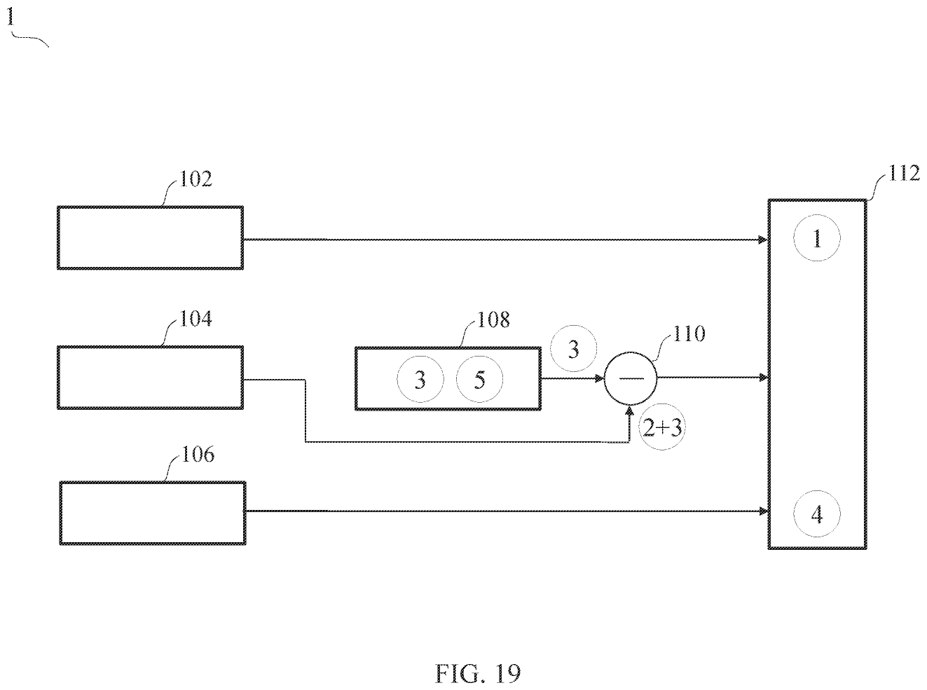

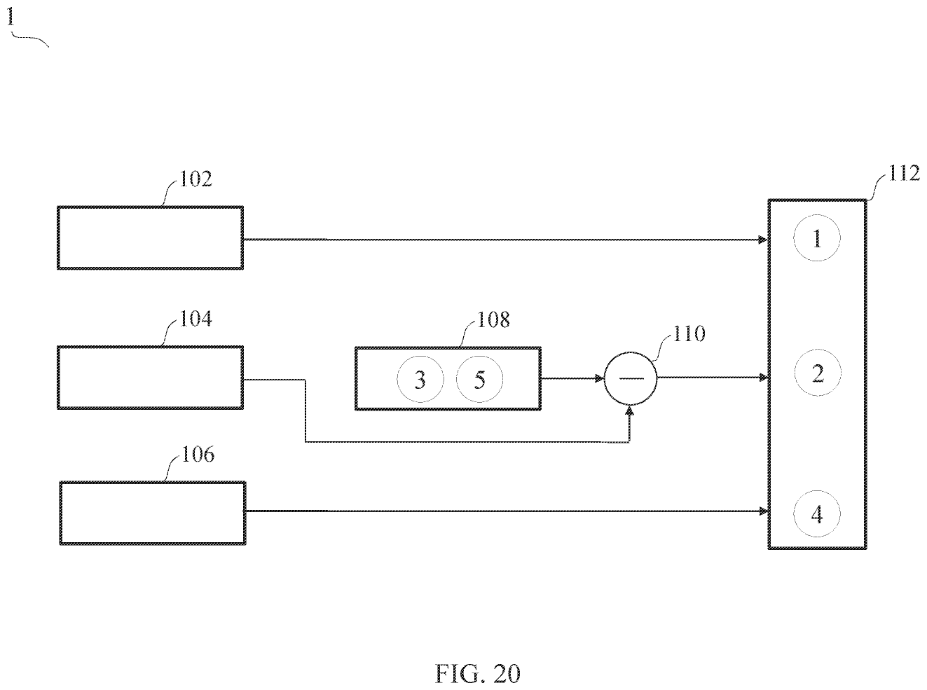

Therefore, the controller in the machine 1 can directly output the attributes of the nodes in the first input storage device 102 and the third input storage device 106 to the storage device 112 for use. However, for the computation result of the attributes of the nodes in the second input storage device 104, a reverse computation is required to decode the attribute of the node that is actually requested. As shown in FIG. 19, the controller in the machine 1 reads out the summation result of the attribute of the node \textcircled{2} and the attribute of the node \textcircled{3}, and reads the attribute of the node \textcircled{3} from the storage device 108, and then uses the subtractor 110 to subtract the attribute of the node \textcircled{3} from the summation result of the attribute of the node \textcircled{3} and the attribute of the node \textcircled{2} to obtain the attribute of the node \textcircled{2}, and outputs the attribute to the storage device 112 for use, as shown in FIG. 20.

The machine 2, similar to the machine 1, also serves as a worker, and hence, the embodiment of the operation of the machine 2 is similar to that of the machine 1, and the details is omitted for the sake of brevity. Further, since the machine 1, the machine 2, and the machine 3 all have the opportunity to serve as a master or a worker, the machine 1, the machine 2, and the machine 3 can all have the components required as a master and as a worker at the same time, so that they can be used in the operation as a master and a worker.

The graph neural network machine, graph neural network system, and graph neural network processing method according to the present disclosure can speed up the overall training time without cutting any edge in the graph neural network, and hence, would not affect the training effect.

The foregoing description briefly sets forth the features of certain embodiments of the present application so that persons having ordinary skill in the art more fully understand the various aspects of the disclosure of the present application. It will be apparent to those having ordinary skill in the art that they can easily use the disclosure of the present application as a basis for designing or modifying other processes and structures to achieve the same purposes and/or benefits as the embodiments herein. It should be understood by those having ordinary skill in the art that these equivalent implementations still fall within the spirit and scope of the disclosure of the present application and that they may be subject to various variations, substitutions, and alterations without departing from the spirit and scope of the present disclosure.

What is claimed is:

1. A graph neural network processing method, for use in a master, wherein the master, a first worker and a second worker train the graph neural network in a distributed environment, and the master, the first worker and the second worker respectively store information of some of nodes of the graph neural network, wherein the graph neural network method comprises:
receiving a first request sent from the first worker and a second request sent from the second worker, wherein the first worker sends the first request to the master to obtain at least an attribute of a first requested node, and the second worker sends the second request to the master to obtain at least an attribute of a second requested node;
determining whether the first requested node and the second requested node are the same nodes and generating a determination result accordingly; and
selectively performing broadcast or unicast to the first worker and the second worker, at least based on the determination result.

2. The graph neural network processing method of claim 1, wherein the graph neural network comprises a first node, wherein the first requested node and the second requested node are both the first node, wherein the step of determining whether the first requested node and the second requested node are the same nodes, and generating the determination result accordingly comprises:
determining that the first requested node and the second requested node are both the first node; and
the step of selectively performing broadcast or unicast to the first worker and the second worker at least based on the determination result comprises:
performing broadcast to the first worker and the second worker, wherein a broadcast content includes an attribute of the first node.

3. The graph neural network processing method of claim 1, wherein the master records a storage situation of attributes of a plurality of nodes in the graph neural network in the first worker and the second worker.

4. The graph neural network processing method of claim 3, wherein the graph neural network comprises a first node and a second node, wherein the first requested node is the first node, and the second requested node is the second node, wherein the step of determining whether the first requested node and the second requested node are the same nodes, and generating the determination result accordingly comprises:
determining that the first requested node and the second requested node are not the same nodes; and
the step of selectively performing broadcast or unicast to the first worker and the second worker at least based on the determination result comprises:
selectively performing broadcast or unicast to the first worker and the second worker based on a storage situation of attributes of a plurality of nodes in the graph neural network in the first worker and the second worker.

5. The graph neural network processing method of claim 4, wherein the first worker stores an attribute of the second node, and the second worker stores an attribute of the first node, and the step of selectively performing broadcast or unicast to the first worker and the second worker based on the storage situation of attributes of the plurality of nodes in the graph neural network in the first worker and the second worker comprises:
performing broadcast to the first worker and the second worker, wherein a broadcast content includes a summation result of the attribute of the first node and the attribute of the second node.

6. The graph neural network processing method of claim 4, wherein the first worker does not store the attribute of the second node, and the second worker does not store the attribute of the first node, and the step of selectively performing broadcast or unicast to the first worker and the second worker based on the storage situation of attributes of the plurality of nodes in the graph neural network in the first worker and the second worker comprises:
performing a first unicast to send the attribute of the first node to the first worker, and performing a second unicast to send the attribute of the second node to the second worker.

7. The graph neural network processing method of claim 4, wherein the first worker stores the attribute of the second node, and the second worker does not store the attribute of the first node, and the step of selectively performing broadcast or unicast to the first worker and the second worker based on the storage situation of attributes of the plurality of nodes in the graph neural network in the first worker and the second worker comprises:
performing a first unicast to send the attribute of the first node to the first worker, and performing a second unicast to send the attribute of the second node to the second worker.

8. The graph neural network processing method of claim 6, wherein the first unicast and the second unicast are not performed simultaneously.

9. A graph neural network machine, for use as a master, wherein the master, a first worker and second worker train the graph neural network in a distributed environment, the master, the first worker and the second worker respectively store information of some of nodes of the graph neural network, wherein the graph neural network machine comprises:
an input storage device, configured to store a first request sent from the first worker and a second request sent from the second worker, wherein the first worker sends the first request to the master to obtain at least an attribute of the first requested node, and the second worker sends the second request to the master to obtain at least an attribute of the second requested node; and
a controller, coupled to the input storage device, wherein the controller is configured to determine whether the first requested node and the second requested node are the same nodes, and generate a determination result accordingly, and the controller selectively performs broadcast or unicast to the first worker and the second worker at least based on the determination result.

10. The graph neural network machine of claim 9, wherein the graph neural network comprises a first node, and the first requested node and the second requested node are both the first node, wherein the controller determines that the first requested node and the second requested node are the same nodes, and the controller performs broadcast to the first worker and the second worker, wherein a broadcast content includes the attribute of the first node.

11. The graph neural network machine of claim 9, wherein the graph neural network machine further comprises;
a lookup table, configured to record a storage situation of attributes of a plurality of nodes in the graph neural network in the first worker and the second worker.

12. The graph neural network machine of claim 11, wherein the graph neural network comprises a first node and a second node, and the first requested node is the first node, the second requested node is the second node, wherein the controller determines that the first requested node and the second requested node are not the same node, and the controller further selectively performs broadcast or unicast to the first worker and the second worker based on the storage situation of attributes of the plurality of nodes in the graph neural network in the first worker and the second worker,
wherein, the lookup table records that the first worker stores the attribute of the second node, and the second worker stores the attribute of the first node, and the controller performs broadcast to the first worker and the second worker, wherein a broadcast content includes a summation result of the attribute of the first node and the attribute of the second node.

13. The graph neural network machine of claim 12, wherein the lookup table records that the first worker does not store the attribute of the second node, and the second worker does not store the attribute of the first node, and the controller sends the attribute of the first node to the first worker through a first unicast, and the controller sends the attribute of the second node to the second worker through a second unicast.

14. The graph neural network machine of claim 12, wherein the lookup table records that the first worker stores the attribute of the second node, and the second worker does not store the attribute of the first node, and the controller sends the attribute of the first node to the first worker through a first unicast, and the controller sends the attribute of the second node to the second worker through a second unicast.

15. The graph neural network machine of claim 13, wherein the first unicast and the second unicast are not performed simultaneously.

16. A graph neural network system, comprising:
a first machine, comprising a first graph neural network machine for use as a master, wherein the master, a first worker and second worker train the graph neural network in a distributed environment, the master, the first worker and the second worker respectively store information of some of nodes of the graph neural network, wherein the first graph neural network machine comprises:
an input storage device, configured to store a first request sent from the first worker and a second request sent from the second worker, wherein the first worker sends the first request to the master to obtain at least an attribute of the first requested node, and the second worker sends the second request to the master to obtain at least an attribute of the second requested node; and
a controller, coupled to the input storage device, wherein the controller is configured to determine whether the first requested node and the second requested node are the same nodes, and generate a determination result accordingly, and the controller selectively performs broadcast or unicast to the first worker and the second worker at least based on the determination result.

17. The graph neural network system of claim 16, further comprising:
a second machine, comprising a second graph neural network machine for use as the first worker, wherein the second graph neural network machine comprises:
an input storage device, configured to store a broadcast content sent from the master, wherein the first worker sends the first request to the master to obtain at least an attribute of the first requested node, and the first worker stores the attribute of the second node; and
a controller, coupled to the input storage device, wherein the controller subtracts the attribute of the second node from the broadcast content to obtain the attribute of the first node.

18. The graph neural network system of claim 17, wherein the first machine and the second machine are arranged in a same device or different devices.

19. The graph neural network system of claim 18, wherein the first machine and the second machine are two different cores in a same device or different devices.

20. The graph neural network system of claim 18, wherein the first machine and the second machine run two different processes on a same device or different devices.
